(19) United States
(12) Patent Application Publication
(10) Pub. No.: US 2015/0253908 A1
(43) Pub. Date: Sep. 10, 2015

(54) ELECTRICAL DEVICE FOR DETERMINING USER INPUT BY USING A MAGNETOMETER

(71) Applicant: WIDEVANTAGE INC., Seoul (KR)

(72) Inventor: Jae Yong Go, Seoul (KR)

(21) Appl. No.: 14/427,836

(22) PCT Filed: Sep. 16, 2013
(86) PCT No.: PCT/KR2013/008347

§ 371 Date: Mar. 12, 2015

(30) Foreign Application Priority Data
Sep. 14, 2012 (KR) 10-2012-0102474

(51) Int. Cl. G06F 3/046; G01D 5/12

(52) U.S. Cl. CPC G06F 3/046; G01D 5/12

(57) ABSTRACT

An electrical device is configured to determine a user input by using a mobile communication terminal provided with a magnetometer for accurate determination of a user input, through a control function performed by the magnetometer in response to the determined result. The electrical device includes a magnetic field sensor for sensing a magnetic field from an n-DOF external object provided with a magnetic field generating part, and producing a magnetic field vector of limited m dimensions, with n>m; and a control part for storing physical prior information about motions of the external object, and determining information about displacements and rotations of the external object based on the limited, m-dimensional magnetic field vector and the physical prior information.

### TECHNICAL FIELD

The present invention relates to an electrical device, and more particularly, to an electrical device for determining a user input by using a mobile communication terminal provided with a magnetometer for accurate determination of a user input, through a control function performed by the magnetometer in response to the determination result.

### BACKGROUND ART

Since the beginning of the PC era, a mouse has been used as a 2D or 2-DOF (degree of freedom) device for inputting movements in both x-axis and y-axis directions. Then, U.S. Pat. No. 7,217,448 to Logitech Inc. in USA disclosed the use of two optical sensors to increase the resolution of a mouse, and the implementation of a 3-DOF configuration capable of recognizing the rotating angle r of the mouse. Later, a laptop computer with a track pad was introduced and used widely such that the flat screen of the computer could be turned off when a finger is tapped on against the screen. Along with the emergence of tablet PCs and smart phones, such track pads were evolutionally advanced to a touch screen input device where the user directly presses or pans an object that appears to be transparent on a display screen operating in an (electrostatic) capacitive or static pressure mode. The touch screen receives a user input made by pressing a fingertip against the screen or using a pen or a stylus. In particular, Wacom Co., Ltd. of Japan produced a stylus by employing its patented technology (U.S. Pat. No. 6,556,190) based on the electromagnetic and magnetic resonance power delivery called EMR (electromagnetic resonance), which has a wide range of applications in POS input devices and some smart phones and tablets. This Wacom stylus features advanced functions, i.e. it is capable of distinguishing the tip of a stylus from a finger or even a greater portion of the hand that might be on the input pad for better processing, and of measuring an applied pressure in order to adjust the thickness of a pen stroke. In addition to these Wacom pens, other touch pens that may be produced at lower costs have been used as a major input device for smart phones and tablets. A touch pen is an accessory for general input purposes, such as, drawing by touching a capacitive multi-touch screen with a nib made of conductive materials or simply by applying a mechanical pressure to a static pressure screen, or selecting a menu, dragging and so on without using a finger. Although the touch pen is also a 2-DOF input device for inputting coordinates on a flat screen, it is not capable of distinguishing the touch of a touch pen from the touch of a palm against the touch screen such that it cannot only allow the user to write on the touch screen with a greater portion of the user's hand is still in touch with the screen, but it also cannot measure an applied pressure, failing to adjust the stroke of the pen.

In particular, when an object to be handled is a 3D object, it is hard to derive an intuitive and easy operation from the 2D operation using, such as, a touch screen, a mouse or a track pad for example. First of all, an object in 3 dimensions has 6-DOF, i.e. dragging (zoom, pan) along three independent axes and rotation (roll, pitch, yaw) about three independent axes. Even with the multi-touch method, two fingers can only lead to 4-DOF, and an additional finger besides the thumb and the index finger does not necessarily facilitate an intuitive input of a high DOF as it is not likely to move independently.

One way of resolving the aforementioned issue is a 3D mouse. Among others, 3d Connexion has succeeded to a great extent and introduced a knob type mouse in U.S. Pat. No. 7,215,323, making it possible for the user to hold the mouse in one hand and drag and turn it in 3D directions, thereby achieving 6-DOF. Unfortunately, this mouse has a number of embedded sensors, a complicated circuit to which power needs to be supplied, and a mechanically complicated structure, which together cause higher implementation costs.

Moreover, there has been an attempt to solve the issue of input in 3D with the help of software and diverse accelerometers installed in any existing smart phones such as iPhones, or tablets. For instance, Duke University in USA ran a project called ‘Phone Point Pen’, in which the gyrometer and the accelerometer of a smart phone track and recognize a letter written in the air by a user using the smart phone, and then change them into pen strokes on the software. Also, InvenSense Inc. in USA claimed in its report “Motion Processing” that a sensor can measure a change in the speed as well as the angle and displacement of the 6-DOF through the “sensor fusion algorithm” which is responsible for removing noises for example and performing proper differential and integral operations, with reference to all inputs from the gyrometer, the accelerometer and the e-Compass. But it is also the well-accepted opinion that obtaining an absolute displacement via integrating the acceleration twice is practically impossible especially in the surroundings where a lot of noises are generated by slight shaking of the hand, inclination due to a shaft of the centroid of an object, the motion of the user's body itself, rotation and so on. Except for special situations where the acceleration associated with the motion is sufficiently larger than noises, such as, writing letters in big and fast motion in the air, it is virtually impossible in the majority of cases to obtain a substantially accurate displacement value by the noise. One cannot possibly apply this technology to the situation especially where a mouse is manipulated or operated within a short distance range of several centimeters.

Those simple input devices available up to date, including a mouse, a trackball, a static pressure-capacitive stylus or the like, are advantageous in that they are inexpensive and have a small volume such that they can easily be applied to portable computers such as smart phones or tablets. However, they are also disadvantageous in that an input operation is troublesome and not intuitive, and for a single person to possess all of these different input devices, the sensors, circuits, communication interfaces, power supplies etc. installed in the respective devices together make the devices rather expensive, heavy and bulky.

Meanwhile, there is a more complicated input device, a multi-touch screen, which has already been provided to portable computers, allowing the user to press it with a finger or a capacitive stylus and to make various inputs intuitively on the flat surface, e.g., taking notes, selecting, zooming, panning and so on. However, this stylus also cannot distinguish the location of the nib from a palm, thereby forcing the user to write in the air while his or her hand is being lifted up over the screen. Further, if a virtual 3D object needs to be operated by the software, it is very difficult to perform an intuitive operation.

Other motion game devices such as Will or Kinect include, in addition to the accessory, diverse sensors, a micro controller, a power supply, and the like such that their hardware construction cost is too high to be applied to a portable computer, and more fundamentally those devices use a camera as a sensor, meaning that the line of sight from the sensor to the user's body or the target item has to be secured, which together make them inappropriate for use in making an input to a portable apparatus where the user uses several fingers for operation in the immediate vicinity from the display screen.

Furthermore, U.S. Pat. No. 8,376,854 discloses the use of a compass sensor to recognize a gesture based on a movement of the magnetic element. However, this compass sensor can only sense a movement of the magnetic element, and cannot verify the detailed information such as the displacement or the rotation of the magnetic element.

### DISCLOSURE OF THE INVENTION

The present invention makes use of a magnetometer already available in a mobile communication terminal or a portable computer for making a motion input, such that the user can operate a movable object (accessory) having a magnet only without any of a sensor, a circuit and a power supply, and the mobile communication terminal or the portable computer can recognize or determine different intuitive motions and then change the status of an object on the software in order to facilitate the operations of geospatial applications such as Graphic editor, motion games, Street view or Google earth. In particular, the use of a magnetic field makes it possible to resolve the problem of securing the line of sight, a possible issue in mobile communication terminals or portable computers that are operated mainly by using fingers in a limited space.

According to the present invention, in order to figure out motions of an object (accessory) in 3D space having 6-DOF with a magnetometer of a limited dimension installed in a mobile communication terminal or a portable computer, the motions of the object (accessory) are measured at different time points using physical constraints and presumptions that are applied while the object (accessory) is moving, or imposes physical limits on the motions of the object (accessory) and the corresponding motion values are calculated by a control part 280 (software) of the mobile communication terminal or the portable computer.

Also, according to the present invention, in order to make additional use of an acceleration sensor, e.g., an accelerometer or gyroscope available in most existing portable computers, for the recognition of a motion, an object (accessory) having a magnet is fixed, and a user holds a mobile communication terminal or a portable computer in hand and operates it, allowing the mobile communication terminal or the portable computer to determine a relative location from the object and proceed its processing.

Accordingly, the present invention provides an electrical device for determining a user input by using a magnetometer, the electrical device comprising: a magnetic field sensor for sensing a magnetic field from an n-DOF external object provided with a magnetic field generating part, and producing a magnetic field vector of limited m dimensions, with n>m; and a control part for storing physical prior information about motions of the external object, and determining information about 3D displacements (x, y, z) and 3D rotations (roll, pitch, yaw) of the external object based on the limited, m-dimensional magnetic field vector and the physical prior information.

The physical prior information includes at least one of motion paths, motion types and presumed information about motions of the external object or the magnetic field generating part. In particular, the motion paths include a linear motion, a motion made by the external object or the magnetic field generating part approaching the electrical device via a shortest distance, and so on. The motion types include a rolling motion, a processional motion, a linear motion, a parabolic orbit motion, and a spin motion of a magnet contained inside the external object in a fixed state, for example. The presumed information includes finger motion estimation values, the absence of an external force, and so on.

The control part preferably uses at least two limited, m-dimensional magnetic field vectors that are obtained at different time points.

The control part determines motion parameters independent of time, by using the at least two limited, m-dimensional magnetic vectors, in which the motion parameters independent of time include a coefficient of friction, a coefficient of elasticity and so on.

The control part preferably stores information about an angle between the external object and a magnetic field generating part within the external object.

The electrical device includes a touch screen. Preferably, the control part additionally uses input information from the touch screen and determines information about 3D displacements (x, y, z) and 3D rotations (roll, pitch, yaw) of the external object.

The electrical device further includes a microphone. Preferably, the control part additionally uses sound information from the microphone, and determines information about 3D displacements (x, y, z) and 3D rotations (roll, pitch, yaw) of the external object.

The magnetometer and at least one of the external object and the magnetic field generating part are preferably movable.

The control part preferably determines information about 3D displacements (x, y, z) and 3D rotations (roll, pitch, yaw) of the movable magnetometer.

The magnetometer preferably measures a plurality of magnetic fields forming a predefined angle, or measures a coded magnetic field.

Moreover, the present invention provides a method for determining a user input by using a magnetometer, the method comprising: sensing a magnetic field from an n-DOF external object provided with a magnetic field generating part, and producing a magnetic field vector of limited m dimensions, with n>m; and determining information about 3D displacements (x, y, z) and 3D rotations (roll, pitch, yaw) of the external object based on the limited, m-dimensional magnetic field vector and pre-stored physical prior information about the external object.

The present invention makes use of a magnetometer, a touch screen and so on, which are already available in a portable computer for making a motion input to the portable computer, such that various user inputs such as intuitive motions can be made or input to a computer software through an accessory having merely a magnet or touch screen input touch points, without any of a sensor, a circuit and a power supply, and then the status of an object on the software is changed in order to facilitate the operations of geospatial applications such as Graphic editor, motion games, Street view or Google earth.

Moreover, through a magnetic field-sensing operation, the present invention effectively overcomes the problem of securing the line of sight for sensing in a portable computer that is operated mainly by using fingers in a limited space. Also, the present invention makes it possible to calculate necessary motion values for the accessory only with limited inputs from the magnetometer that senses a magnetic field into the form of a 3D vector and to change actions or colors of a content displayed on the screen, such that an operation in response to a user input can be performed.

In addition, the present invention involves at least two types of sensors; especially in case of a portable computer, the coordinates of a pressed point on a touch screen as well as the value of a magnetic field vector sensed in a 3D magnetometer are referred together. As such, low-cost, smaller input accessories as compared with those existing ones can be implemented, which in turn can increase the DOF of an input and enables convenient, intuitive inputs from the user, resulting in improved user convenience.

Furthermore, according to the present invention, as the user makes an input by moving a smart phone, a microphone already available in such a portable device can be used for recognition even when those motions of the user to be sensed, e.g., putting the smart phone on the ground and dragging, holding the smart phone in the air and returning it to a convenient location, or trampling may be done away from the portable computer by several tens of centimeters or more.

### BRIEF DESCRIPTION OF THE DRAWINGS

The above and other objects, features and advantages of the present invention will become apparent from the following description of a preferred embodiment given in conjunction with the accompanying drawings, in which:

FIG. 1 illustrates a user input system composed of an electrical device of the present invention, and a movable object provided with a magnet.

FIG. 2 is a first embodiment of the user input system in FIG. 1.

FIG. 3 is a second embodiment of the user input system in FIG. 1.

FIG. 4 is a third embodiment of the user input system in FIG. 1.

FIG. 5 is a fourth embodiment of the user input system in FIG. 1.

FIG. 6 is a fifth embodiment of the user input system in FIG. 1.

FIG. 7 is a sixth embodiment of the user input system in FIG. 1.

FIG. 8 is a seventh embodiment of the user input system in FIG. 1.

FIG. 9 is an eighth embodiment of the user input system in FIG. 1.

### BEST MODE FOR CARRYING OUT THE INVENTION

The following will now describe the present invention in more detail, with reference to the accompanying drawings and exemplary embodiments.

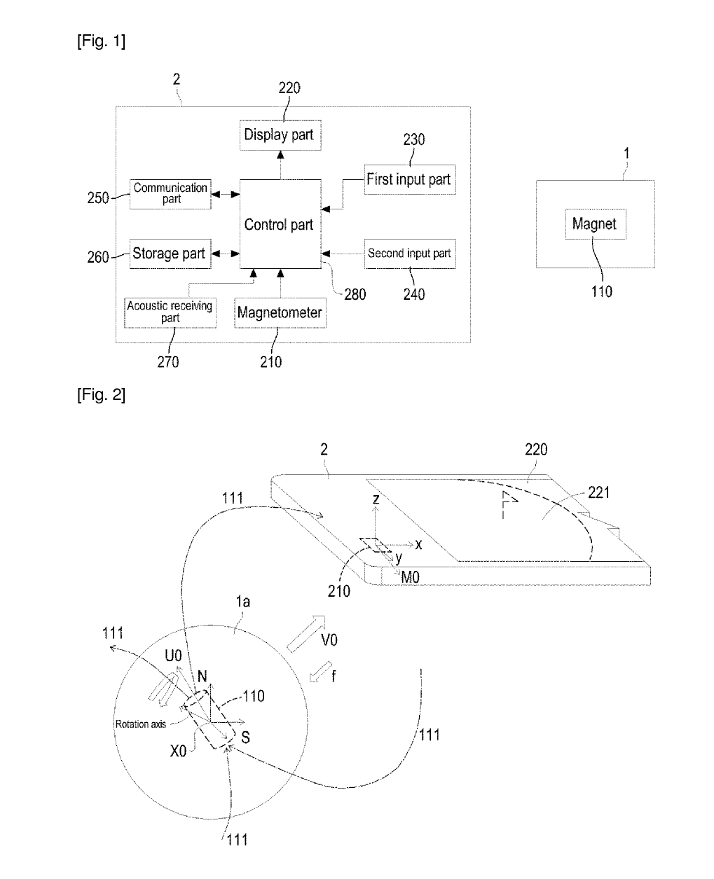

FIG. 1 illustrates a user input system including an electrical device of the present invention, and a movable object provided with a magnet.

As shown, the user input system includes a movable object 1 provided with a magnet 110, and an electrical device 2 for sensing and processing a magnetic field from the magnet 110.

The object 1 is composed of a body with the magnet 110 provided to the inner or outer surface. The object 1 can be in various forms, including, for example, a mouse, a bullet, a touch pen, a ring, a dice or the like.

The electrical device 2 can be implemented in a mobile communication terminal or a computer, and includes a magnetometer 210 for sensing a magnetic field or a change in the magnetic field, a display part 220 for displaying screens or information of a variety of programs, a first input part 230, which is a touch screen for obtaining a touch input, formed on the outer surface of the display part 220 part facing outside, a second input part 240 implemented in a case (not shown) of the electrical device 2 other than the display part 220, such as buttons, a communication part 250 for performing wired or wireless communications with external communication equipment (not shown), a storage part 260 for storing programs or information necessary to execute specific functions of the electrical device 2, and for storing physical prior information or constraints necessary to determine user input information from a motion of the movable object 1 or a motion of the electrical device 2, an acoustic receiving part 270 for receiving an electric signal or an acoustic signal from outside and then applying acoustic information to a control part 280, and the control part 280 for executing specific functions of the electrical device 2, as well as for determining a user input by using the physical prior information or constraints stored in the storage part 260 or by using a sensed value of the magnetic field provided from the magnetometer 210, or for processing other programs or data in response to the thus determined input. Another element of the electrical device 2, i.e. a power supply for supplying power to each element, will not be described here since it is well known to the art to which the present invention pertains. Also, the communication part 250 can be optional.

The magnetometer 210 senses a magnetic field vector of limited number of dimensions, and applies the sensed value to the control part 280. The magnetometer 210 is capable of measuring, for example, a 3D magnetic field vector, and at least one magnetometer 210 is provided to the magnetometer 210.

Since the display part 220, the first and second input parts 230 and 240, the communication part 250, the storage part 260 and the acoustic receiving part 270 described above are well known technical construction in the art, they will not be explained in further detail. The following embodiments will now describe the process performed by the control part 280 for accurate determination and processing of a user input, by evaluating the input values through the magnetometer 210, the first input part 230 and the acoustic receiving part 270, based on the physical prior information or constraints stored in the storage part 260.

In this embodiment, the magnetometer 210 senses a magnetic field from an n-DOF object having a magnet as a magnetic field generating part to generate an m-dimensional magnetic field vector, wherein n>m. The control part 280 determines the displacement and rotation information of the n-DOF object, on the basis of the physical prior information about a motion of the object 1 and the limited, m-dimensional magnetic field vector of the objection 1. In particular, in order to reduce the number of the magnetometers 210, for example, the physical prior information about a motion of the object 1 may include information about (n−m) DOF or more of the object 1.

Moreover, according to this embodiment, in order to reduce the number of the magnetometers 210, the control part 280 determines the displacement and rotation information of the object 1, by using the physical prior information about a motion of the object 1, and directly limiting the DOF of a motion of the object 1. For example, the DOF of a motion of the object 1 is limited to 5, and this information about the limitation of the DOF of a motion of the object 1 is stored in the storage part 260 in advance. Later, based on such information about the limitation, the control part 280 can determine the displacement and rotation information of the object 1. Here, the information about the limitation of the DOF of a motion of the object 1 is also included in the physical prior information of a motion of the object 1.

FIG. 2 is a first embodiment of the user input system illustrated in FIG. 1. As shown in FIG. 1, in one embodiment of the present invention, the control part 280 of the electrical device 2 senses, through the magnetometer 210, a change in a magnetic field 111 caused by a magnet 110 which is fixed at the center of inside a ball 1a, i.e. a movable object, and rolls together with as the ball 1a rolls on the ground; searches the location of the ball 1a based on the sensed result; and reflects it in a display screen serving as a virtual object or space such as a putting green that is shown on the display part 220, or in the status of a content 221. In addition, the control part 280 employs a user input that is determined based on a change in the magnetic field from the magneto sensor 210 through the user input of a program, game or App in process, for example, so as to change the status of the program, game or App, or to perform the command input, the environment setting, the mode change, changing the display screen or the like.

While the magnetometer 210 receives a 3D magnetic field input, a ball or a rigid body 1a of the accessory performs a 6-DOF motion involving 3D displacements (x, y, z) and 3D rotations (roll, pitch, yaw) in 3D space. Therefore, the magnetic field input obtained from the 3D magnetometer 210 is not sufficient to define the location of the accessory including a magnet of the ball, that is, the location of the ball 1a.

The storage part 260 stores physical constraints that are applied as the accessory moves to find the location or angle of an external accessory having a higher DOF, from a limited number value measured by the magnetometer 210, and the control part 280 executes corresponding calculation based on these physical constraints.

That is to say, accurate determination of the displacement and rotation information of a ball is attained only when a user using the system of FIG. 1 rolls the ball 1a in an area separated from the electrical device 2 by at least 30 cm for example. Through the display part 220, the electrical device 2 informs the user of rules that are easy to keep and intuitive in daily life, e.g., the area within the radial distance of 30 cm has to be a flat plane without curvature, the friction force due to a surface material has to be constant without any sharp change, etc. Then, assuming that the user kept these rules, the control part 280 is able to find a motion of the ball 1a accurately. The storage part 260 stores these rules as the physical constraints or prior information, and the control part 280 utilizes these rules.

When the ball 1a rolls and gets close within the distance of 30 cm or less from the electrical device 2, the magnetic field 111 becomes a large value that is noticeably distinguishable from noises irrelevant to a motion of the ball 1a. As such, the control part 280 can determine the information relevant to a motion of the ball 1a, by using the magnetic field 111 measured by the magnetometer 210. The ball 1a rolls around the rotation axis.

The control part 280 decides such a change in the magnetic field as an approach of the ball 1a, and reads a magnetic field sensor value M0, which is a 3D vector, getting ready to reflect the value in the status of the content 221. Since the user does not know where he or she rolled the ball 1a, the location of the ball 1a, X0, becomes a variable to find, and is a 2D value as the ball 1a is on the plane. However, even though the control part 280 is informed of the magnetic strength of the magnet 110 sharing the same center with the ball 1a, an angle formed between the magnet dipole and the magnetosensor 210 is also given by a 2D vector value U0, and based on this, a variable M0 can be defined as in the following Equation 1:

M0=F(X0,U0) Equation 1

That is to say, the magnetometer value M0 is defined by a function (F) between the variables X0 and U0, and these X0 and U0 might also be found using an inverse function of F. The problem here is that the magnetometer value M0 is a 3D value, while the DOF of the variables X0 and U0 equals to 4D (2D+2D), it is not possible to obtain the variable X0. Unless other presumptions are used for the aforementioned problem, the location of the ball 1a on the plane cannot even be found. A traditional way to solve this was placing at least 9 magnetometers in scattered locations, and employing a high-priced data connection bus for complete synchronization of them, thereby gathering all sensed values at once and obtaining the 3D location and angle through a non-linear optimization.

In the present invention, physical prior information and a number of measurement values by time are employed in order to obtain the location of the ball 1a with help of a limited number of the magnetometers 210. In other words, it is presumed that, with t0 indicating the time when the magnetic field vector M0 is obtained, the speed of the ball 1a at t0 traveling in the same direction by inertia is V0, i.e. a 2D vector value, of which speed is unknown, and while the travel direction is unchanged and the travel speed is determined by a material of the flat plane, the control part 280 uniformly accelerated by an unknown friction coefficient (f). Even under the presumption that the flat plane will not experience gravity-induced bending, it is not significantly different from a real situation. With such physical prior information or presumption, if a magnetic field vector M1 is obtained at a time point t1 after a certain period of time has passed from the time point t0, the magnetic field vector M1 may have a relationship with the location X1 of the center of the ball and latitude/longitude angle U1 of the magnet 110 as indicated in the following Equation 2.

M1=F(X1,U1) Equation 2

wherein X1 is a value determined by the speed V0 at a location relative from X0, the friction coefficient f and the time difference (t1−t0), among which the time t0 and t1 are confirmed by the control part 280 using an embedded timer. The angle U1 of the magnet 110 is a value that is also determined by a radius (r) of the ball from the location U0, a friction coefficient (f) and a time difference (t1−t0), where the radius (r) of the ball 1a corresponds to the physical prior information previously stored in the storage part 260, and the control part 280 calculates the time difference (t1−t0). Therefore, the magnetic field vector M1 satisfies the following Equation 3.

M1=F′(X0,U0,V0,f) Equation 3

Again, at a next time point (t2), a value of the magnetic field vector (M2) equally satisfies the relationship in Equation 4.

M2=F″(X0,U0,V0,f) Equation 4

Now, 9 equations are obtained from three 3D magnetic field vectors M0, M1 and M2 (=3×3), and 7 variables including X0, U0, V0, f and so on still remain unknown. Through the above equation, the control part 280 can calculate X0, U0, V0 and F, and further it can determine all of X0, X1, X2 as well as U0, U1, U2. The control part 280 can use those sensed values of the magnetometer at different points of time to verify the vector information (displacement, rotation) of an object having a high DOF compared to the number of dimensions of the magnetometer 210,

Also, even when more presumptions, such as, the ball 1a rolls by skidding on the floor with a certain given spin speed as in bowling or pool, are made, or another presumption, such as, it is allowed to put an iPad on a tilted surface as in golf putting (physical prior information), the 3D magnetometer 210 can still verify the displacement and rotation information, with help of additional sampling at staggered time intervals. Of course, an error might occur as the floor is not perfectly flat or the friction coefficients are not uniform, but merely a few simple presumptions stored in the control part 280 or the storage part 260 could be sufficient to move a virtual object substantially correspondingly to the intuition of a person, and if the magnet 110 is still within the sensing range after sampling, it is possible to correct the location by continuing the sampling and to improve the accuracy of parameters such as the friction coefficient that was not known.

Therefore, in order to obtain sufficient information about an object having a higher DOP than the dimensions of a magnetometer using such a magnetometer of limited dimensions, it is necessary to understand that the object in a certain time interval is given with a location and an angle at each point of time by a predefined force therein according to the physical speed and acceleration laws. Then, using location, angle, speed and angular speed of an unknown object at a certain point of time as well as parameters associated with a constant motion independent of the passage of time as variable, and sampling the sensed values obtained by the magnetometer at different points of time, and using the sensor measurement values that are equal to or higher than the DOF created by those unknown variables as constraints, it is possible to obtain the unknown location, angle, speed, acceleration, motion parameters and so on. The physical laws for speed and acceleration can be inertia, angular momentum, gravity, friction force or the like, and time-independent parameters described above can be a coefficient of friction, a coefficient of elasticity, mass, slope or the like.

In case of using a dipole magnet having one N pole and one S pole, either point symmetric or line symmetric magnetic fields are formed on every plane perpendicular to the dipole, such that a motion like spinning with respect to the dipole might not be read. When even such information about spinning is needed in the control part 280, it is suitable to use a number of magnets so as to break the symmetry of a magnet, or use a coded magnet. Particularly, it is preferable to arrange two or three dipole magnets in perpendicular locations to each other. In addition, measurement can be performed, for example, by rotating magnets with respect to an axis perpendicular to the dipole, presuming that each magnet rotates with its own momentum. Moreover, two or three electromagnets being perpendicular to each other may be electrically driven in sequence and then a corresponding magnetic field at a right angle can be measured. Also, for a moving object, a signal can be measured using an RFID as a kind of the electromagnet and supplying power to the electromagnet by a magnetic induction or magnetic resonance method, without a separate power supply.

The control part 280 can use the displacement and rotation information of the ball 1a to control a virtual putting green as well as various virtual objects, and display the same on the display part 220. For instance, the control part 280 can arrange bowling pins or insert a pool table or marble game board outputted in computer graphics. Further, the control part 280 makes it possible for users at a remote distance from each other to enjoy a game over the network.

With the same principle, the magnetometer 210 measures the trajectory of an object being thrown, and under the presumption that the object is flying without being subject to any other unknown external forces but to the gravity and friction force only, the control part 280 interprets data from the magnetosensor at different points of time to find the location, speed and acceleration of the ball, and reflect the results in a virtual object. For instance, if an electrical device 2 is installed in a small space it only occupies a small area within a limited distance, and an object being thrown will then hit against the wall and fall within a short moment. However, a virtual space in the screen of the display part 220 has no limit, and a virtual object being thrown could be able to fly far away and hit a target in the virtual space. Here, the space may be set to above the earth, the moon, the Saturn or the like, with different gravitational accelerations being applied respectively. Also, the type of games may include diverse sports, such as basketball, boomerang, throwing a sword, or a shooting game. Additionally, the object throwing ways can be implemented in various manners, e.g., using one hand, using a slingshot from a certain distance away, striking with a golf club and the like. The electrical device 2 according to the present invention can check simply whether the object has hit the target on the surface of a touch screen, and it can also measure how further the object being thrown has flied, passing through the touch screen or an adjacent space and estimate what shape of a curve may be drawn as the object spins, and then reflect these in a corresponding game. In case of a sword-throwing game for example, beyond the simple measurement of coordinates where the thrown sword and the touch screen have met each other to see whether or not an object moving on the touch screen has hit the target, the electrical device can vividly show how the object rotates, passing the touch screen or adjacent plane, what shape of a trajectory is drawn by the flying object, and whether the object actually hit a 3D target that was set in further inside the screen from different viewpoints of the user, following the trajectory of the sword. Tracing the trajectory of the thrown sword with the magnetometer 210 can also be carried out similarly the embodiment shown in FIG. 2. That is to say, merely using the 3D magnetometer 210 cannot provide a spatial location of a 6-DOF magnet inside the sword. However, once the sword leaves the hand, it is presumed that the sword is not subject to any of those already known nature laws, namely, the law of inertia and the law of gravity, or any other unknown forces, but it moves by an angular momentum. Then, using those sensed values of the magnetometer 210 at plural time points, the control part 280 can find an unknown variable as the number of samples increases despite the limited dimensions of each sensed data. Since the sampling operation is done sufficiently fast, a virtual sword flying in the display part 220 can be reproduced in real time more.

All the methods described above make it possible to provide a simulation of an object being thrown, by simply using a magnetometer frequently used in a small-size tablet such as iPad, or a smart phone. Considering that the game involves a flying object, it is preferable to have magnetometers distributed on a large screen and in a broad space. The system according to the present invention makes it possible to perform broad-band magnetic field sensing by employing universal communications including, for example, WiFi, Bluetooth, Ethernet, USB and the like, which that do not support a plurality of magnetometers and synchronization. For instance, in case of a plurality of electrical devices 2, e.g., smart phones, installed on the wall and doing communications with a central computer or with each other through WiFi, each magnetometer in the respective smart phone can sense an object being thrown, and update the output of every smart phone screen installed.

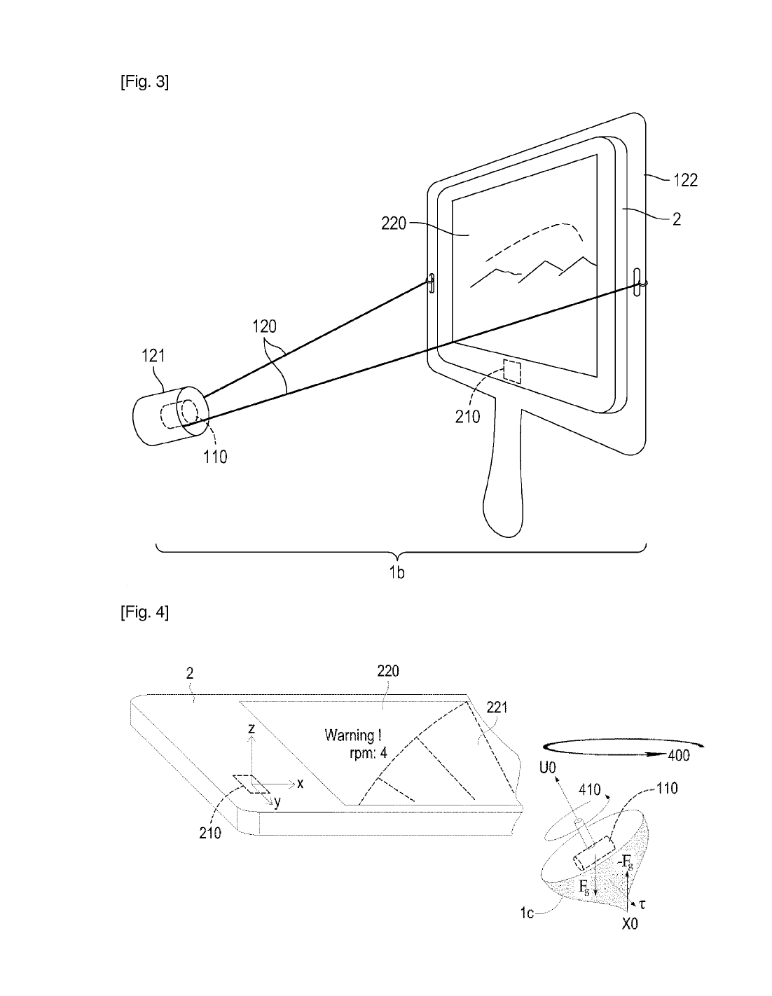

FIG. 3 is a second embodiment of the user input system illustrated in FIG. 1. Referring to FIG. 3, a slingshot accessory 1b is adapted such that rubber straps 120 of the slingshot may be connected to a transparent accessory frame 122 serving to receive the electrical device 2. If a shooting object 121 having the magnet 110 therein is sufficiently light, it would be mainly under the influence of the elastic force of the rubber straps 120, rather than of the gravity. It is impossible for the 3D magnetometer 210 to find the location of the shooting object 121 while the user keeps moving the shooting object 121 in horizontal and vertical directions for aiming, but as soon as the object leaves the user's hand, it is presumed that the magnet inside the shooting object would move according to the physical laws that can be described with a limited number of unknown parameters, such as the direction and magnitude of the elastic force of the elastic straps, and that no other force cannot be applied to the object. Based on this physical prior information and corresponding sample data obtained from many magnetometers 210, the control part 280 can trace the trajectory and rotations of the shoot object in space.

FIG. 4 is a third embodiment of the user input system illustrated in FIG. 1. The control part 280 makes use of the sensed data from the magnetometer 210 to reflect motions of an object by other nature laws, in addition to rolling or throwing near the magnetometer 210, in a virtual object displayed on the display part 220 and then displays it afresh. By way of example, FIG. 4 shows that the control part 280 checks the rotation of a top 1c and displays it on the display part 220. When the top 1c having a magnet 110 therein starts spinning above or next to the electrical device 2, the top 1c spins, as soon as it leaves the hand, by an angular momentum 410, the friction force and the gravity (Fg), and it also does precession 400 with torque (τ in FIG. 4) generated by a reaction force (−Fg) at the center of the top. The control part 280 uses physical prior information about the precession and rotation motions of the top 1c to find unknown parameters (coefficients) of such motion from the measurement values obtained from the magnetometer at different points of time in a certain time interval, thereby being able to obtain the location X0 or the current angle U0 of the top. Once this locational information is obtained, the control part 280 can output an animation in real time mode, e.g. showing a fancy top 221 based on the spinning position of the top 1c, or gives a warning alarm about the precession, or have a top-spinning game with a remote user. Likewise, it can also output various accessories, including a carousel frequently used in a roulette or board game for example.

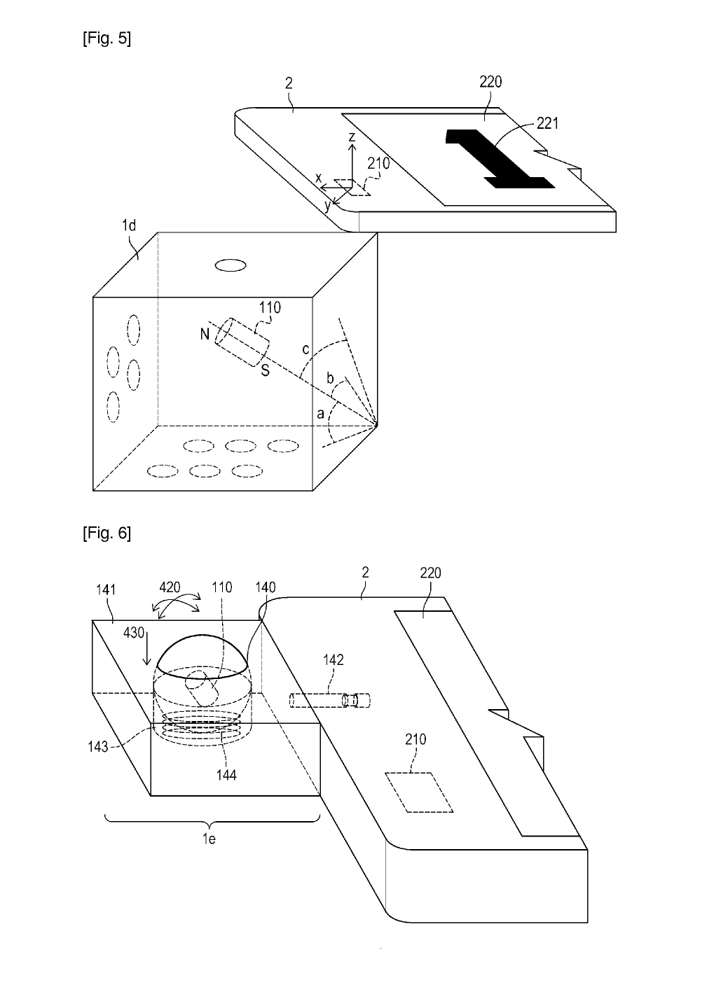

FIG. 5 is a fourth embodiment of the user input system illustrated in FIG. 1. Here, a dice 1d is shown as another embodiment. A magnet 110 is inserted into the dice 1d in a manner that the dipole of the dice 1d forms an angle a and −a with the sides 1 and 6, an angle b and −b with the sides 2 and 5, and an angle c and −c with the sides 3 and 4, respectively. Here, c is determined by a and b, and a, b and c are preferably different as far as possible from each other. As the dipole N-S of the magnet 110 (0°≦a, b, c≦90°) forms one angle out of six angles a, b, c, −a, −b and −c from the plane according to the number appearing on top of the dice 1d, it is possible to distinguish which number side is on top. In the electrical device 2, the storage part 260 stores information about the six angles a, b, c, −a, −b and −c, and information about the size or volume of the dice 1d. The electrical device 2 uses the sensed values of the magnetometer 210 to determine an angle, and then it can decide which number out of 1 to 6 appears on top of the dice 1d. The user throws the dice 1d, the dice 1d lands on the floor, and the user brings the dice 1d near the electrical device 2 towards the magnetometer 210. While the dice 1d is dragging in a relatively linear direction on the flat floor (i.e. this corresponds to physical prior information), the control part 280 obtains a magnetic field value at each sampling time measured by the magnetometer 210. Since an angle formed between the floor and the magnet 110 depending on which appears on top of the dice 1d, the pattern of magnetic field values at each sampling time also varies. Therefore, the control part 280 can decide which number appears on top of the dice 1d, based on a change in the magnetic field values at different points of time, In addition, the control part 280 can estimate which appears on top of the dice 1d, based on the physical relations, such as, the center of gravity, the edges or vertices of the dice 1d or the like.

Also, the control part 280 can display the number on top of the dice 1d on the display part 220, or move a horse or show optional strategies according to the number appeared on top of the dice and wait for the selection from the user, and makes it possible for all users distant from each other to enjoy the game over the network.

FIG. 6 is a fifth embodiment of the user input system illustrated in FIG. 1. As yet another embodiment of the present invention, it presents a trackball 1e device which is composed of a magnet and a simple structure and is capable of providing pointing information to the electrical device 2. Since the trackball 1e rotates by user's fingers, it does not seem that the trackball moves by a physical force described as a simple known parameter during a certain time interval. In this case, in order to figure out a user input by using the limited, dimensional magnetometer 210, the electrical device 2 stores, as physical prior information, that there is a physically set limit to the DOF of a motion of the magnet 110 or there is a limit to the user input methods, so as to reduce the DOF of a motion of the magnet 110 and measures a corresponding magnetic field. That is to say, in case of the trackball 1e, the magnet 110 is embedded inside a rotary ball 140, and this magnet 110 measures a 3D magnetic field vector that influences the magnetometer 210. The portion indicated by a thick solid line in the ball 140 is exposed to outside, which the user can touch with a finger and rolls it. The dotted line portion is inserted into a groove inside a frame 141. The groove inside the frame 141 gets narrower upwards from the inner bottom, ensuring that the ball 140 does not pop out. While the ball 140 inside the frame 141 rotates and turns within the groove, when the user inputs something the frame 141 that holds this ball 140 is fixed at a certain interval with the electrical device 2 or at a particular position with a mechanical treatment to prevent any relative movement, or the electrical device 2 informs the user through the display part 220 that the frame should be put at a designated place and immobilized. One way to fix the frame 141 is making the frame sufficiently heavy and then placing it on the electrical device 2 or attaching it to the side of the electrical device 2 or attaching to the electrical device 2 using tongs or a suction cup. In particular, a plug type frame 141 simply designed to be plugged in and fixed without having any electric contact point may be plugged in and fixed to a headset jack or USB or connector of the electrical device 2 through a tool 142 firmly attached thereto, or it can be bent into a C shape together with the plug such that the trackball 1e may be fixed and immobilized upwards to the electrical device 2. In addition, there are many other ways for fixing the electrical device 2 case with the frame, such as, integrating the two into one body, or integrating the frame and a plug instrument of a charging cable into one body. As such, the frame 141 of the trackball 1e is fixed to the electrical device 2, and the ball 140 is housed in the groove formed in the frame 141 holding the ball 140. As far as the ball 140 is allowed to rotate, the displacement (x, y, z) of the 6-DOF magnet 110 therein is set and the DOF is limited. If the trackball 1e is sufficiently near the magnetometer 210, based on the sensed values of a magnetic force provided to the control part 280 from the 3D magnetometer 210 and based on the presumption (i.e. physical prior information) that the ball 1e is inserted into the groove of the frame 141 within a certain distance from the electrical device 2, it is possible to calculate a necessary ball rotation vector (roll, pitch), and using this calculated ball rotation vector, it is possible to change and display a virtual object or motor in the display part 220.

Furthermore, the control part 280 can recognize a click motion of the ball 140 in a height direction 430. This click in the height direction constructs the lower end part inside the groove where the ball 140 is housed into a cylindrical shape, and an elastic member such as a spring 144 is provided into the groove under the ball 140. In particular, as the trackball 1e described above can be installed outside the electrical device 2, not above the touch screen, the user does not need to cover that small display part 220 screen with one hand, but enjoys the benefit of using a broad area of the display part 220 screen, which in turn increases the user convenience.

Similar to the trackball, a point stick (or trackpoint) of IBM, which had been broadly used as a pointing device for those traditional laptop computers, can also be incorporated as an ultra-small accessory for use in a portable computer. It is also possible to implement a hand-operated joystick, which has one press button and designed for 2D manipulations (roll, pitch), simply into a 3-DOF device with a magnet and a magnetometer. It would be obvious to a person skilled in the art that the buttons on the trackball, point stick and joystick described above may be implemented with analog buttons that distinguish a pressing depth, besides distinguishing between being pressed and being lifted.

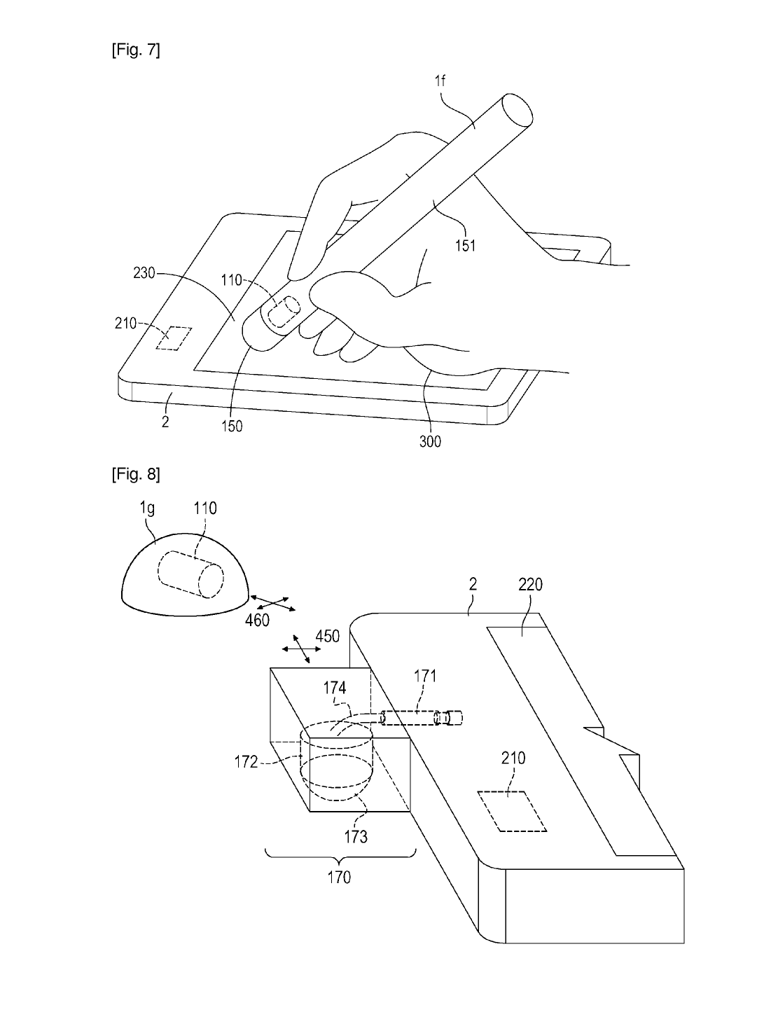

FIG. 7 is a sixth embodiment of the user input system illustrated in FIG. 1.

The DOF of an accessory such as the trackball which is manually operated by a person, not by the law of motions, should be limited to 3 for the 3D magnetometer 210 to be able to sense a motion. Moreover, to receive a motion input having even a higher DOP from the pointing device used for inputting a person's operation, one accessory cooperates with other kinds of sensors available in the electrical device 20 to perform sensing and to figure out the motion having a higher DOF. Under the presumption that data provided from at least two sensors are relevant to data obtained from one accessory and as a result of processing and analyzing the data, it is possible to sense a motion having a DOF corresponding to the sum of all the dimensions of the respective sensors.

The sixth embodiment is an example of simple accessories having a magnet 110 introduced into a touch pen 1f as a typical stylus, in which a press input of a nib 150 against the touch screen 230 together with magnetic field inputs by the magnetometer 210 are provided to receive an intuitive motion input in consideration of all DOFs. Those traditional touch pens are used for 2D sensing, which involves touching a point (x, y) on the touch screen 230 operating under the electrostatic or static pressure mode employed for a portable computer. However, since the touch pen 1f itself is a cube placed in space, it also has 6 DOFs. Accordingly, by adding the magnet 110 for an additional reference to 3D magnetic field values of the magnetometer 210, the location of the nib 150 on the touch screen 230 as well as the location and direction of the touch pen 1f as a cube in general are determined, thereby enabling a variety of inputs and gestures. In other words, when the nib 150 touches a point on the touch screen 230, the control part 280 confirms 3D information that lies on the touch position (x, y) of the nib 150 on the touch screen 230 having a fixed height (z), and finds a complete location and angle of the 6-DOF touch pen 1f in 3D space upon the addition of a 3D vector input provided from the magnetometer 210. In addition, it is optionally possible to estimate 3D information in many spaces, from relative locations of the touch screen 230 and magnetometer 210. The rotational angle of a pen holder 151 may be limited such that one side of the pen holder 151 of the cylindrical touch pen 1f is bent in the height direction of the cylinder to help the user hold the touch pen if conveniently with his or her thumb, and the control part 280 uses these constraints and 3D information in order to check on which side of the electrical device 2 the user is located.

Usually, a majority of smart phones or tables in the art use either electrostatic touch screens or static pressure touch screens. As a result, the screens do not distinguish a press from the skin or a palm 300 from a press from the nib 150. This forces the user to write while holding his or her hand way above in the air, being careful not to touch the touch screen with the skin or palm, which causes difficulties in writing letters naturally and nails sometimes can get in the way of the user's writing. However, in case of the touch pen 1f having the magnet 110 embedded therein as shown in FIG. 7, the additional magnetic field sensing makes it possible for the control part 280 to identify a press of the nib 150 even if both the nib 150 and the palm 300 may have touched the touch screen 230.

Further, as the control part 280 can recognize the entire touch pen 1f as a cube, it can check the position of a clicked point as well as the direction and slope of the pen holder 151 and a degree of rotation of the touch pen if with respect to the pen holder 151. That is to say, the control part 280 can provide intuitive and diverse user interfaces by using information about the displacement or rotation of the touch pen 1f, and information which indicates which input is of the touch pen if and which input is not of the touch pen if among many touches on the screen.

To begin with, the control part 280 can measure a pen pressure, namely, a pressure applied to the touch pen if and reflect this measurement in the thickness of a pen stroke for example. Two possible ways to measure a pen pressure are as follows: 1) when the user presses the touch pen 1f strongly, the touch pen 1f tends to move in the vertical direction on the display part 220, more specifically towards the index finger of the user. Then the control part 280 can determine the pen pressure based on an angle formed in that direction. 2) If the nib 150 is made from a rubber material having an appropriate elasticity, the height of the magnet 110 changes by a force applied to the touch pen 1f. Then the control part 280 can determine the pen pressure based on a change in the height of the magnet. This method 2) can be done very accurately by analyzing continuous motions of the touch pen 1f.

Meanwhile, an increase in the DOF makes it possible for a simultaneous input of many variables. While moving an object by dotting and dragging a pen (viewpoint pan), an angle formed between the pen and the screen is adjusted at the same time and the object (viewpoint) is zoomed in/out, or the pen is rotated simultaneously, thereby enabling an intuitive user interface for rotating the object (viewpoint). The slope angle of the pen during the zoom in/out operation is preferably as nearly perpendicular to the slope angle in the index finger direction that is determined by the control part 280 for detecting a pen pressure. Moreover, a gesture-based input is possible as well. In other words, while touching with a pen, if the upper tip of the pen is laid in a linear direction or erected, it is recognized as zoom in/out, and the upper tip of the pen is rotated in a circular trajectory, thereby enabling the rotation thereof. Needless to say, this operation may be done intuitively on a multi-touch screen by a user interface called rubber-banding using two fingers. However, considering a situation where the user who is already using a pen at the moment has to put the pen down and uses his or her fingers for rubber-banding and then pick up the pen again, the user interface of the invention is a far more swift and intuitive.

In an object creation or edit mode on the screen, even if the same dot seemed to be made, its effects could be manifested differently depending on an angle formed between the pen and an object or the screen. That is to say, when digging or pasting an object with a touch of the pen, the object could be dug or pasted at different angles depending on an angle of the pen. For instance, when the pen is rotated, the object may be curled up or turn into a different color accordingly.

The different between a touch from the touch pen 1f and a touch from the hand may be reflected in an input. For instance, suppose that a virtual rocket needs to be made in space. Then, the pen is used for displaying the location and angle of the rocket in a whole space, while at the same time the user can use two fingers to adjust wings of the rocket or the length of a gun attached thereto. As this is happening in multi-touch environment, multi-touches from different fingers, and multi-touches between a finger and the pen will naturally be distinguished and reflected in an input. Further, while the user may input using a finger, he or she can also write naturally, while one palm of the user is supporting the screen. This is made possible, based on the fact that the pen holder tends to tilt in a direction where the rest of the hand holding the pen is, and by measuring an angle between the thumb and the pen holder. That is, one could guess from the above fact that a touch input being made at a certain part of the touch screen where a palm of the user is going to be is ignored, and only a touch input on the opposite side is received. In this manner, both pen inputs and finger inputs can be made naturally, while a palm is still put on the screen.

In addition, other gestures of the touch pen 1f, including, for example, shaking or overturning in the air above the touch screen 220 without touching the touch screen 230 are sensed by the magnetometer 210, and the control part 280 recognizes a magnetic field vector or a change in the sensed magnetic field so as to perform corresponding data processing or screen processing. The control part 280 can change an input mode. For example, whenever the touch pen 1f is overturned, the input mode can be switched to a write mode or an erase mode. Also, whenever the pen sways in a horizontal direction, the color of letters being written, or the size of an eraser for deleting the written letters can be changed. Moreover, whenever the pen sways in a vertical direction, the input mode may be changed into pen writing trajectory inputs or into rectangular, circle, straight line inputs. To be short, the control part 280 can change the screen shown on the display part 220, or change a setting value or setting environment in a program or App currently in operation, in response to a recognized gesture.

As shown in FIG. 7, instead of embedding a magnet in a stylus, it is possible to produce a small, simple accessory that is easy to attach and has a built-in magnet, and then attach this accessory to a normal touch pen. A user can use this as it is, or wear this on a finger as a ring. When using such a magnet ring worn on the index finger for touching, magnetic field information generated by a magnet in the ring is also obtained, in addition to the touch location. As such, it becomes easier to determine where was pressed by the tip of the index finger as intended by the user, even though many places on the touch screen 230 may have been pressed with a palm and the tip of the index finger, the thumb or the like. Here, the physical prior information about the magnet ring being worn on the index finger is recognized by the control part 280. Further, as already described in FIG. 6, higher DOF, intuitive inputs are now possible based on diverse angles and directions. When two people are looking at the same portable computer screen, i.e., one wearing the ring and the other not wearing the ring, it is useful for finding out who made a touch. For instance, in a game where players compete against each other for cutting incoming fruits, it can be useful for finding out who cuts those flying fruits the most. Also, the user can make more diverse inputs by distinguishing between the index finger and the other fingers.

The magnet ring described above may be applied for short writing with one hand, without necessarily taking a smart phone or tablet out of a handbag or a pocket, which is realized by making use of the penetration nature of a magnetic field. Although it is difficult to find a motion of the ring in a high-DOF space only with the limited dimensional data, an estimate of the motion of a finger (although not accurate) can still be obtained from a few presumptions (physical prior information) and simple information (e.g., parked location, telephone number or the like) can be input when time presses. Meanwhile, in order to estimate a motion of the magnet inside the ring based on data from the magnetometer, a special presumption is used in regard to how the user's hand moves during writing. In one possible way, under the presumption that during writing, a pen and the fingers holding the pen tend to make nearly parallel motions, values that represent the user's writing style very well are substituted into ‘roll, pitch, yaw’ of a ring and then the location of the ring (x, y, z) is estimated to get the location of a pen stroke. Depending on how a smart phone is tilted, relative values of roll, pitch and yaw change accordingly. Therefore, when the user writes something, values that are read by the accelerometer and the gyroscope in the smart phone are used for correcting an angle, so as to help the user write at a certain angle in a more convenient way. It is also important to detect whether the user is drawing a stroke or is simply moving to another start position for a next stroke. This can be determined by looking at z (that is to say, the height of the tip of a finger) among other components obtained from the presumption. Other presumptions are also possible; for example, if an estimated speed of the ring is fast it is regarded as a pen stroke, and if the speed is slow it is regarded as a motion. However, since the presumption that there will not be a much difference in heights and thus the motion will be generally parallel is not completely accurate either, instead of adopting a binary processing method, the control part 280 preferably changes and outputs the thickness or color of a pen stroke depending on an estimated height or speed.

In addition, because the roll, yaw, pitch parameters used for the presumption (prior information) can vary significantly depending on a given situation, the electrical device 2 stores original magnetic field data obtained from the magnetometer, and then in case the user does not recognize, the electrical device 2 can estimate what the user wrote, modifying the parameters used for the presumption with the original data.

For the computer to estimate the location of a ring, drawing a stroke, a simple motion or the like, the electrical device 2 provides preset presumption (prior information) to the user such that the user may be able to write according to given instructions. For instance, based on the presumption described above, the electrical device 2 may instruct the user to write without turning the pen too much, or to move fingers quickly with a force when writing, otherwise moving fingers slowly.

The pointing device with a magnet and the sensing method as discussed in FIG. 7 are not particularly limited to the pen or ring shape, and any tools of an oval shape or a thimble shape, having a magnet provided therein, can be applied to both handheld and attachment uses. Main features here include that the magnet and the touch are both used for a higher DOF, intuitive input, and as a result thereof, it is possible to receive an input of a high dimension corresponding to the sum of the number of limited dimensions of the magnetometer and the number of limited dimensions of the touch screen. Also, under the presumption that a contact point sensed by the touch screen and the magnet sensed by the magnetometer are either fixed with respect to each other in space or their relative motions are limited, the location of an object for input can be found more specifically.

FIG. 8 is a seventh embodiment of the user input system illustrated in FIG. 1.

FIG. 8 shows yet another example of the method of the invention, in which an object 1g having a magnet 110 fixed therein is secured onto the plane, and the electrical device 2 is moved using one hand, similar to a mouse. Following this motion, the control part 280 senses a change in the values of the magnetometer 210 as a function of a change in the location of the magnet 110 that moves relatively to the electrical device 2 so as to find how the electrical device 2 has been moved, and then performs a necessary operation, such as, changing the screen. As the user holds the electrical device 2 and drags it on the ground, the output thereof, such as, a cursor may be executed separately in a computer, and the motion of the electrical device 2 is transmitted to a separate computer through the communication part 250 like WiFi or Bluetooth. In order to learn about the motions of the electrical device 2 from the magnetometer 210, there are limiting conditions that the object 1g having a magnet 110 should be fixed, and the electric device 2 should be dragged on the plane in an area close to the object 1g. Because the electrical device 2 remains in parallel with the plane where the magnet 110 is laid and the height of the magnetometer 210 on the ground is constant while the electrical device 2 is being dragged, the roll and pitch components and a degree of freedom in a height difference (z) between the magnet 110 and the magnetometer 210 in the electrical device 2 disappear. Therefore, it becomes easier to derive (x, y, yaw) components from the values of a 3D magnetometer. Referring to the yaw component, the (x, y) coordinates obtained can be interpreted in the coordinate system 450 of the body of a phone, not in the coordinate system 460 of a magnet. In other words, regardless of an accessory 1 being laid on the plane at whatever angle, it is possible to interpret how much the accessory 1 has moved with respect of the vertical direction as well as of the horizontal direction 450.

What matters here is distinguishing between a state where the electrical device 2 is being dragged and a state where the electrical device 2 is picked up and delivered to a convenient location. Even when the electrical device 2 is dragged on the plane, after a certain point, the user often lifts the electrical device 2 and brings it to a more convenient location for manipulation and then drags it from there again. However, under the presumption that the electrical device 2 stays on the plane, the interpretation of measurement values from the magnetometer 210 does not tell whether or not the electrical device 2 has been held up in the air. If the electrical device 2 was actually held up in the air, based on the presumption described above, the control part 280 would perform a calculation process, believing that the electrical device 2 has been dragged to a wrong location and in a wrong angle on the plane. Therefore, it is important to distinguish whether the electrical device 2 is being dragged, or is moving in the air.

This can be detected by combining the accelerometer and the gyroscope already present in most of smartphones. In other words, if the electrical device moves in a direction perpendicular to the gravity and then is influenced by a linear acceleration or rotation in a direction that is not perpendicular to the gravity, the control part regards this as the electrical device being held up in the air. On the other hand, if the electrical device has landed on the ground and is influenced by a relatively large angular acceleration or linear acceleration, accompanied by vibrations, and then maintains a constant state with respect to the gravity direction, the control part regards this as the electrical device being landed on the ground again. A smart phone without this accurate sensing function can employ an additional part 170 provided with a plug 171 which is plugged in a headset jack of a portable computer, a microphone 172 electrically connected to the plug, facing the ground, and a solid part 173 which scratches the ground as the phone scratches the ground and generates noises therefrom, the noises being inputted to a computer by the additional part 170.

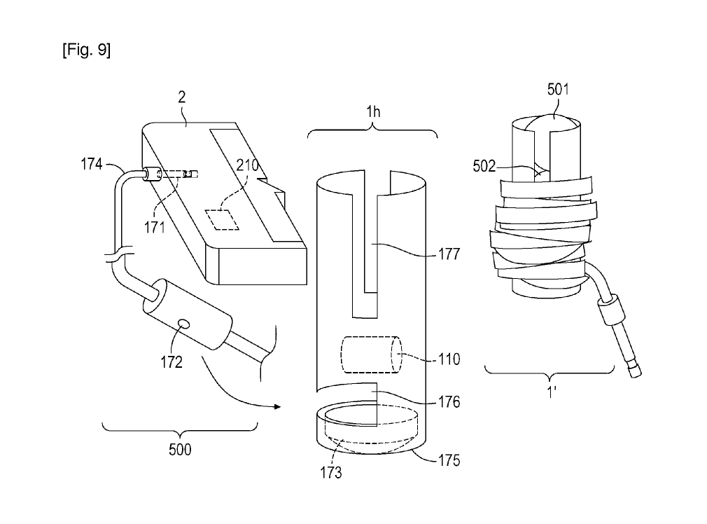

As in the example of FIG. 8, it is also important here to distinguish whether the electrical device 2 is being dragged on the ground or being held up in the air. To this end, the microphone 172 is provided to the bottom of the electrical device 2, and serves to recognize the dragging of the electrical device 2 on the ground as a sound. The microphone 172 is connected by a sufficiently long electric line 174, and a plug 171 where a headset jack of the electrical device 2 is plugged in is provided to the other end of the microphone. In the electrical device 2, therefore, any detected sound is transmitted to the control part 280 through an acoustic receiving part 270. As shown in FIG. 9, an acoustic acquisition part 170 has a body 173 for receiving a microphone 172 therein, a microphone 172, and an electric line for electrically connecting the microphone 172 and a plug 171.

FIG. 9 is an eighth embodiment of the user input system illustrated in FIG. 1.

To the user, the dragging sound on the ground may be very soft enough to be negligible, but the microphone 172 which is located nearby and receives a sound via a solid may sense a sufficiently large noise. The solid 173 which serves to generate such noise and transmit it to the microphone 172 can be made from diverse materials and provided to the bottom 175 of a mouse. The electrical device 2 receives an input from the microphone via the acoustic receiving part 270, and decides whether the mouse 1h is being dragged. If not, the electrical device 2 does not move the cursor on the screen.

The mouse 1h is composed only of a magnet 110 and a simple body as shown in FIG. 10, without a separate microphone, electric line or plug. In this case, a microphone 172 of a regular headset 500 the user owns is installed in an empty slit 176 at the lower end of the mouse 1h, a plug 171 of the headset is plugged in the jack of the electrical device 2, and a sensed dragging sound of the mouse 1h on the ground is transmitted to the electrical device 2. The light, simple body of the mouse 1h can also serve as a housing around which a long, easily tangling line of the headset can be wound and which receives an earbud 50 or plug to facilitate a convenient carry-on thereof. A long slit that looks like the one 177 can be formed for the aforementioned housing use, and to distinguish between the front and the rear of the mouse 1h. As this type of mouse 1h is built in a small and simple structure, it can be used as a stylus that the user holds in hand and writes on the display part 220 or a broad plane above the display part 220. It would be obvious to a person skilled in the art that the part to be dragged on the ground and the hand-held part can be connected by materials or parts for promoting the flexibility thereof, thereby enabling to adjust the grasping angle.

Sensing of scratches based on the sound caught by a microphone can also be used for other applications of recognizing simple actions far away from a phone. For instance, suppose that a foot pedal motion made distant from an electrical device needs to be recognized. To this end, a microphone is installed inside the pedal such that one can hear a frictional sound generated between a stepped, moving part of the pedal and a part for supporting the same. This microphone has an electric line and a plug, and uses them to transmit large noises it picked up near the electrical device located at a certain distance. By analyzing this sound, the electrical device can find out whether the pedal has been stepped, or whether the pedal has been stepped and then released. The moving part and the supporting part of the pedal may be designed to have a rugged surface such that the frictional contact between them would be able to make large noises intentionally, and to have a rugged pattern in a certain direction such that the electrical device can distinguish different directions (e.g., whether the pedal has been stepped, or has been stepped and then released).

It is also possible to install a permanent magnet that moves and rotates mechanically by at least one electromagnet or motor fixed in the vicinity of an area where an object having such a magnet discussed in the present invention moves, and to generate a desired magnetic field whenever necessary, thereby pushing or pulling an accessory in a specific direction and implementing a force feedback therefrom.

If the user owns a variety of low-priced, simple structure accessories similar to ones described above, which can be recognized with a magnetometer or touch screen of a portable computer, their applications are not limited only to those portable computers, but are preferably expanded to computing environments without an embedded magnetometer, including, for example, relatively large screen laptop computers or desktop computers, or to wide open spaces where a projection work can be performed. Preferably, this requires at least one magnetometer having limited dimensions, a micro controller for simple control uses, a power module for sampling and conducting a self-data analysis on magnetic field data produced by an accessory if necessary, and a peripheral sensor for transmitting the data through a universal communication module frequently used, including a USB, Bluetooth or WiFi for example. This peripheral device including the above magnetometer may further include a force feedback module as discussed before, or add an embedded-type trackpad or incorporate this with an existing trackpad to enable both touch inputs and magnetic field inputs at the same time. In addition, a number of such peripheral devices may be arranged in scattered locations in space, and instead of using an expensive data bus that supports synchronization among these distributed peripheral devices, sensed values at different points of time in each peripheral device are read and the trajectory of an accessory including a moving magnet according to known physical laws can be obtained. As such, diverse accessories and motion games involving a wide open space can be performed without the need to reinstall relevant equipment, but simply by changing relevant software (program or App).

The embodiments according to the present invention are implemented in the form of a program command to be executed through diverse computer means, and recorded on a computer-readable medium. The computer-readable medium can include a program command, a data file, a data structure and so on, which may be used alone or in any combination thereof. The program command to be recorded on the medium may be specifically designed or constructed, or those well known to a person skilled in the computer software field may also be used. Examples of the computer-readable recording medium include magnetic media, such as hard disks, floppy disks and magnetic tapes; optical media, such as CD-ROMs and DVDs; magneto-optical media, such as floptical disks; and hardware devices, such as ROMs, RAMs, and flash memories, which are specifically designed to store program commands and execute them. Examples of the program command include machine codes similar to ones made by a compiler, and high-level language codes that can be executed by a computer using an interpreter for example. In order to perform the operations of the present invention, the aforementioned hardware device can be constructed to function as at least one software module, and vice versa.

According to the present invention so constructed, the following advantages can be expected.

The present invention allows the user to be able to make his or her operation input in an intuitive and convenient manner in a variety of software, starting with computer games, 2D or 3D graphic editors, google earth and so on. The present invention makes it possible for the user to make a variety of operative instruction command, including zoom, pan, roll, pitch, yaw, selecting a value, etc., for an object in the software of a computer of a portable smart device, by using a pointing device such as a stylus pen or trackball available in any computer equipped with a magnetometer of a limited number of dimensions or a touch screen supporting a multi-touch function. In short, the present invention relates to an input device and method for making an input of hand motions, drawing or clicking of the user into a computing device provided with at least one of a touch screen, a magnetometer, and a microphone as in a smart phone or tablet. Such an input device of the present invention can be implemented as a low-priced accessory which includes a simple tool and a magnet, without additional sensors, circuits or communication modules, yet can sense the location as well as the angle of an object, thereby increasing the input convenience for the user.

The present invention has been described in detail in connection with the exemplary embodiments and the accompanying drawings. However, the scope of the present invention is not limited thereto but is defined by the appended claims.

The scope of the present invention is not limited to the embodiment described and illustrated above but is defined by the appended claims. It will be apparent that those skilled in the art can make various modifications and changes thereto within the scope of the invention defined by the claims. Therefore, the true scope of the present invention should be defined by the technical spirit of the appended claims.

1. An electrical device for determining a user input by using a magnetometer, the electrical device comprising:
at least one magnetic field sensor for sensing a magnetic field from an n-DOF external object provided with a magnetic field generating part, and producing a magnetic field vector of limited m dimensions, with n>m; and
a control part for storing physical prior information about motions of the external object, and determining information about displacements and rotations of the external object based on the limited, m-dimensional magnetic field vector and the physical prior information.

2. The electrical device for determining a user input by using a magnetometer according to claim 1, wherein the physical prior information includes at least one of motion paths, motion types and presumed information about motions of the external object or the magnetic field generating part.

3. The electrical device for determining a user input by using a magnetometer according to claim 1, wherein the control part uses at least two limited, m-dimensional magnetic field vectors that are obtained at different time points.

4. The electrical device for determining a user input by using a magnetometer according to claim 3, wherein the control part determines motion parameters independent of time, by using the at least two limited, m-dimensional magnetic vectors.

5. The electrical device for determining a user input by using a magnetometer according to claim 1, wherein the control part stores information about an angle between the external object and a magnetic field generating part within the external object.

6. The electrical device for determining a user input by using a magnetometer according to claim 1, wherein the electrical device includes a touch screen, and the control part additionally uses input information from the touch screen and determines information about displacements and rotations of the external object.

7. The electrical device for determining a user input by using a magnetometer according to claim 1, wherein the physical prior information includes information about limitations on the degree of freedom of the external object of the magnetic field generating part.

8. The electrical device for determining a user input by using a magnetometer according to claim 1, wherein at least one of the magnetometer and the external object of the magnetic field generating part is movable.

9. The electrical device for determining a user input by using a magnetometer according to claim 8, wherein the control part determines the displacement and rotation information of the movable magnetometer.

10. The electrical device for determining a user input by using a magnetometer according to claim 1, wherein the control part changes a display screen shown on the display part available in the electrical device, or a content, based on the determined displacement and rotation information.

11. A method for determining a user input by using a magnetometer, the method comprising:
sensing a magnetic field from an n-DOF external object provided with a magnetic field generating part and producing a magnetic field vector of limited m dimensions, with n>m; and
determining information about displacements and rotations of the external object based on the limited, m-dimensional magnetic field vector, and the pre-stored physical prior information of the external object.

12. The method for determining a user input by using a magnetometer according to claim 11, wherein the determining involves using at least two limited, m-dimensional magnetic field vectors that are obtained at different time points.

13. The method for determining a user input by using a magnetometer according to claim 12, wherein the determining involves determining motion parameters independent of time, by using the at least two limited, m-dimensional magnetic vectors.

14. The method for determining a user input by using a magnetometer according to claim 11, wherein the method further comprises obtaining input information from a touch screen, and the determining involves using the input information from the touch screen and determining information about displacements and rotations of the external object.

15. The method for determining a user input by using a magnetometer according to claim 11, further comprising:
changing a display screen shown on the display part or a content, based on the determined displacement and rotation information.

16. A non-transitory computer-readable recording medium on which a computer program for executing the method according to claim 11 is recorded.
